(19) United States
(12) Patent Application Publication
(10) Pub. No.: US 2017/0233058 A1
(43) Pub. Date: Aug. 17, 2017

(54) LOWER DECK COMMERCIAL CABIN

(71) Applicant: Zodiac Aerospace

(72) Inventors: Yannick Brunaux, Croix (FR); Sebastien Sivignon, Brax (FR); Alison Gill, Toulouse (FR); Britta Appolt, Kuerten (DE); Claude Martin, Lury Sur Arnon (FR); Ramon Blauwhoff, Leimuiden (NL)

(73) Assignee: Zodiac Aerospace, Plaisir Cedex (FR)

(21) Appl. No.: 15/312,374

(22) PCT Filed: May 29, 2015
(86) PCT No.: PCT/IB2015/054086

§ 371 Date: Nov. 18, 2016

Related U.S. Application Data
(60) Provisional application No. 62/005,271, filed on May 30, 2014.
(60) Provisional application No. 62/109,898, filed on Jan. 30, 2015.

(51) Int. Cl. B64C 1/18; B64D 11/00; B64D 47/08

(52) U.S. Cl. CPC B64C 1/18; B64D 47/08; B64D 11/003; B64D 11/0007; B64C 2001/0027

(57) ABSTRACT

Embodiments of the present invention provide systems and methods for allowing use of what has traditionally been a cargo area of a passenger aircraft to be used as a lower deck passenger cabin. Various modifications to the aircraft are described, as well as various features to be added in order to enhance the passenger experience. For example, there may be provided a lowered technical floor (32), stairs or other passageways (50) provided at both ends of the lower deck cabin, a window replacement technique, an alternative way of storing cabin luggage, or any combination thereof.

### CROSS REFERENCE TO RELATED APPLICATIONS

This application claims the benefit of U.S. Provisional Application Ser. No. 62/005,271, filed May 30, 2014, titled “Lower Deck Cabin Experience” and U.S. Provisional Application Ser. No. 62/109,898, filed Jan. 30, 2015, titled “Lower Deck Commercial Cabin,” the entire contents of each of which are hereby incorporated by reference.

### FIELD OF THE DISCLOSURE

Embodiments of the present disclosure relate generally to systems and features that allow use of what has traditionally been a cargo area of a passenger aircraft to be used as a lower deck cabin. Various modifications to the aircraft are described, as well as various features to be added in order to enhance the passenger experience.

### BACKGROUND

Passenger transport vehicle designers consistently seek to identify improvements that can add additional revenue to the use of the vehicles. This is particularly the case in light of increasing costs of fuel and personnel. For example, adding additional seats to the vehicle can allow an airline or other transport company to earn more revenue from paying passengers. However, space and passenger comfort are also issues to be considered. This is particularly the case for passenger aircraft.

Conventional passenger transport aircraft typically have a main deck cabin on the upper deck and a cargo area on the lower deck. On some routes, however, there is a greater demand for transporting passengers than there is for transporting cargo, leaving a good amount of the cargo area unused. Such flights do not fully use the cargo area. Research has indicated that an average of only about 37% of the cargo area is used nowadays. This may be because many passengers are limiting their luggage due to increased costs and/or only bringing carry-ons. This is particularly the case in Europe when many aircraft are reconfigured for summer travel/shorter flights. Additionally, some market niche airliners only fly regional flights and do not provide for checked luggage.

Accordingly, there is a desire to be able to use some of the space on the cargo area for additional passenger seating. Some aircraft designers have sought to divide an aircraft body, commonly referred to as a fuselage, into a main deck and a lower deck, with the lower deck having its own floor. The goal has been for the lower deck to function as more than storage of luggage or for installation of auxiliary equipment needed for operating the aircraft. For example, in some instances, the lower deck has been designed to host a lounge, sanitary facilities such as lavatories, related waiting areas, beds, and a galley that can deliver food up to the main deck cabin (in some instances, via an elevator in the galley area). These lower decks have not been configured to host passenger seating.

In other lower deck configurations that have been designed to host passenger seating, the lower floors in both the main deck cabin and the lower deck cabin have been altered to have varying heights. This is generally because the lower decks fail to provide sufficient standing height. For example, an aisle section may be lowered in order to accommodate the height of a walking passenger. The seating sections are typically provided at a higher height. However, this is not believed to be a generally desirable configuration. Another solution has been to lower the entire lower deck floor.

Further challenges with using the lower deck for transporting passengers are to provide sufficient structure (e.g., compressible structure space, according to various regulations) beneath the lower decks in order to protect the passengers in the event of a crash landing. There are also challenges to be addressed with respect to a water evacuation, and the appropriate positioning of exit doors for safety purposes. There are further challenges with providing appropriate external outside views for the lower deck. Adding windows by making holes in the skin of an existing aircraft involves new load and added stress. Windows also increase the overall weight of the aircraft. Accordingly, improvements to lower deck cabin configurations are desirable.

### BRIEF SUMMARY

Embodiments of the invention described herein thus provide systems and methods for allowing use of what has traditionally been a cargo area of a passenger aircraft to be used as a lower deck cabin. Various modifications to the aircraft are described, as well as various features to be added in order to enhance the passenger experience. For example, there may be provided a lowered technical floor, stairs or other passageways provided at both ends of the lower deck cabin, a window replacement technique, an alternative way of storing cabin luggage, or any combination thereof.

Particularly, examples of the invention relate to an aircraft fuselage defining an inner space, comprising a main deck cabin, a lower deck cabin (with the lower deck cabin being positioned generally below the aircraft wing plane, which may also be referred to as a horizontal wing plane) and at least one of the following features considered alone or in combination:
a partition floor dividing the internal space into an upper main deck cabin and a lower deck cabin;
the main deck cabin and at least a portion of the lower deck cabin are configured for passenger transport, with each of the main deck cabin and at least a portion of the lower deck cabin having seating areas;
first and second passageways between the upper main deck cabin and the lower deck cabin;
the first passageway positioned at one end of the lower deck cabin seating area;
the second passageway positioned at an opposite end of the lower deck cabin seating area;
the first and/or second passageways comprise stairways;
the stairways comprise one or more straight route segments;
the stairways comprise one or more landings at each change in segment direction;
the lower deck cabin comprises a lowered technical floor;
the lower deck cabin comprises a sidewall having an increased thickness;
the lower deck cabin comprises one or more display screens;
the one or more display screens are for displaying images retrieved from one or more cameras external to the aircraft;
the one or more display screens comprise in-flight entertainment units;
the one or more display screens comprise screens positioned where windows would otherwise be located;
the one or more display screens comprise elongated side walls of the lower deck cabin;
the one or more cameras comprise fiber optic cameras;
the lower deck cabin comprises one or more side bins positioned along a lower deck cabin sidewall;
the lower deck cabin comprises a luggage storage area;
the luggage storage area comprises a plurality of cubbies;
the lower deck comprises a crew rest area;
the lower deck cabin comprises one or more monuments that help reinforce the lower deck structure;
the lower deck comprises seats with energy absorbing properties.

Of course, different features, alternatives and/or embodiments of the present invention can be combined with each other in various arrangements to the extent that they are not incompatible or mutually exclusive of others.

The invention will be better understood and other features and advantages will become apparent upon reading the following detailed description including embodiments for illustrative purposes with reference to the figures, presented as non-limitative examples, which can be used to complete the understanding of the present invention and the description and, where appropriate, contribute to its definition.

### BRIEF DESCRIPTION OF THE DRAWINGS

FIG. 1 shows a side schematic view of an aircraft having an upper main deck cabin and a lower deck cabin according to embodiments described herein.

FIG. 2 shows a cross-sectional view along a portion of the aircraft of FIG. 1.

FIG. 3 shows a cross-sectional view along a portion of a lower deck cabin, illustrating a lowered technical floor and an increased wall thickness.

FIG. 4 shows a cross-sectional view along a portion of a lower deck cabin, illustrating potential movement of one or more pipes.

FIG. 5 shows a top plan view of one potential layout of a lower deck cabin.

FIG. 6 shows a top plan view of one potential layout of an upper main deck cabin.

FIG. 7 shows a top plan view of an alternate potential layout of a lower deck cabin, illustrating a crew rest area.

FIG. 8 shows a forward portion of a lower deck cabin, illustrating a forward set of stairs.

FIG. 9 shows a rear portion of a lower deck cabin, illustrating a rear set of stairs.

FIG. 10 shows a top plan view of an alternate potential layout of a lower deck cabin, illustrating inwardly facing seats.

FIG. 11 shows a cross-sectional view of one seating layout for an upper main deck cabin and a lower deck cabin.

FIG. 12 shows a cross-sectional view of an alternate seating layout for an upper main deck cabin and a lower deck cabin.

FIG. 13 shows a cross-sectional view of an alternate seating layout for an upper main deck cabin and a lower deck cabin.

FIG. 14 shows a cross-sectional view of an alternate seating layout for an upper main deck cabin and a lower deck cabin.

FIG. 15A shows a top plan view of an alternate potential layout for a lower deck cabin, illustrating a luggage storage area.

FIG. 15B shows a close-up view of the luggage storage area of FIG. 15A.

FIG. 16 shows a cross-sectional view of a lower deck cabin along a section containing a galley and a cargo loading door for loading one or more trolleys onto the aircraft.

FIG. 17 shows a cross-sectional view illustrating one embodiment for using a camera to project an image external to the aircraft onto a screen positioned inside the lower deck cabin.

FIG. 18 shows a perspective view of a lower deck cabin with various window replacement options illustrated.

### DETAILED DESCRIPTION

It should be noted that, on figures, structural and/or functional elements which are common to different embodiments may have the same reference sign. Thus, unless otherwise stated, these elements have structural, dimensional and material properties which are identical.

Existing commercial aircraft typically include a passenger cabin (main deck cabin or upper deck cabin) and at least one cargo area, which is typically part of a lower deck. Portions of the cargo area or lower deck often go unused. Accordingly, the present disclosure provides a lower deck that is usable by ticketed passengers. Embodiments of the present invention thus provide a lower deck cabin that includes passenger seating, as well as one or more galleys or catering options, one or more lavatories, and other amenities that are provided to main deck cabin passengers. The lower deck cabin may also be provided with air-conditioning, appropriate safety features, exit doors, an internet connection (either wired or wireless), and passenger entertainment options/screens.

The general goal is for the passenger experience in the lower deck cabin to be similar to the passenger experience in the upper deck cabin. For example, beverage service and other catering functions may be delivered from a lower deck cabin galley. Additionally or alternatively, it is possible to provide one or more vending machines in the lower deck cabin in order to provide catering functions. There may also be provided one or more dedicated lower deck cabin lavatories.

Details of well-known structures and systems that are generally associated with aircraft are not outlined in the following disclosure in order to avoid obscuring or over-complicating this disclosure. Reference to “one embodiment” or “embodiments” do not necessarily refer to the same embodiment, nor are they mutually exclusive from other embodiments. Some features described may be exhibited by some embodiments and not by others. Various features and embodiments described may be combined with one another, depending upon airliner preference and various aircraft needs.

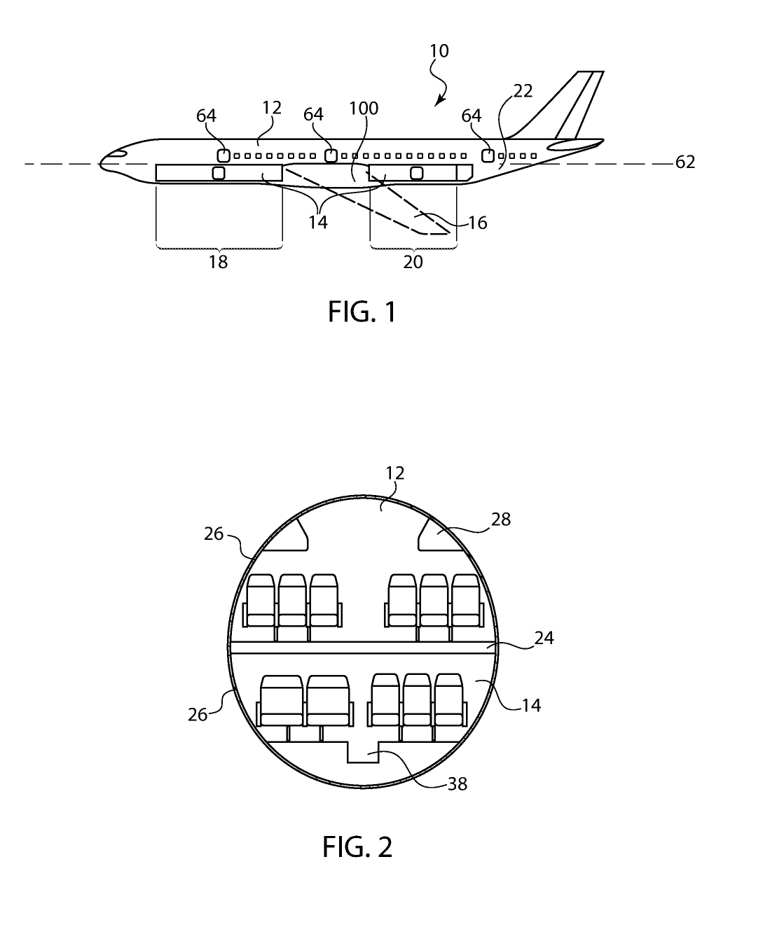

As shown in FIG. 1, an aircraft fuselage 10 may be provided with an main deck cabin 12 (or upper deck cabin 12) and a lower deck cabin 14. In some embodiments, the main deck cabin 12 is generally positioned above the aircraft wing 16 and the lower deck cabin 14 is generally positioned below the aircraft wing 16. The aircraft wing 16 may be referred to as having a “horizontal wing plane,” which generally divides the fuselage 10 horizontally into an upper section (housing the main deck cabin) and a lower section (housing a lower deck cabin). The lower deck cabin 14 may be further divided into a forward portion 18 and/or an aft portion 20. This is generally because a central portion 100 of the aircraft lower deck is designated for the wing centerpiece and/or landing gear bays. It is also possible for there to be one or more cargo area portions 22 provided below the main deck cabin 12.

As shown in FIG. 2, the floor of the main deck cabin 12 forms a partition structure 24 that also functions as a ceiling 24 of the lower deck cabin 14. This structure is also referred to as a partition floor 24. The partition floor 24 may be positioned generally along the horizontal wing plane.

The main deck cabin 12 is provided with traditional passenger walls 26 having windows, as well as overhead passenger compartments 28. The lower deck cabin 14 may also be provided with passenger walls 26, which may be modified as described below.

Because of various challenges with providing windows in the lower deck cabin 14, a window replacement option may be provided, as described below. Because space for overhead passenger compartments 28 may be limited in the lower deck cabin 14, side passenger bins 30 may be provided, as described further below.

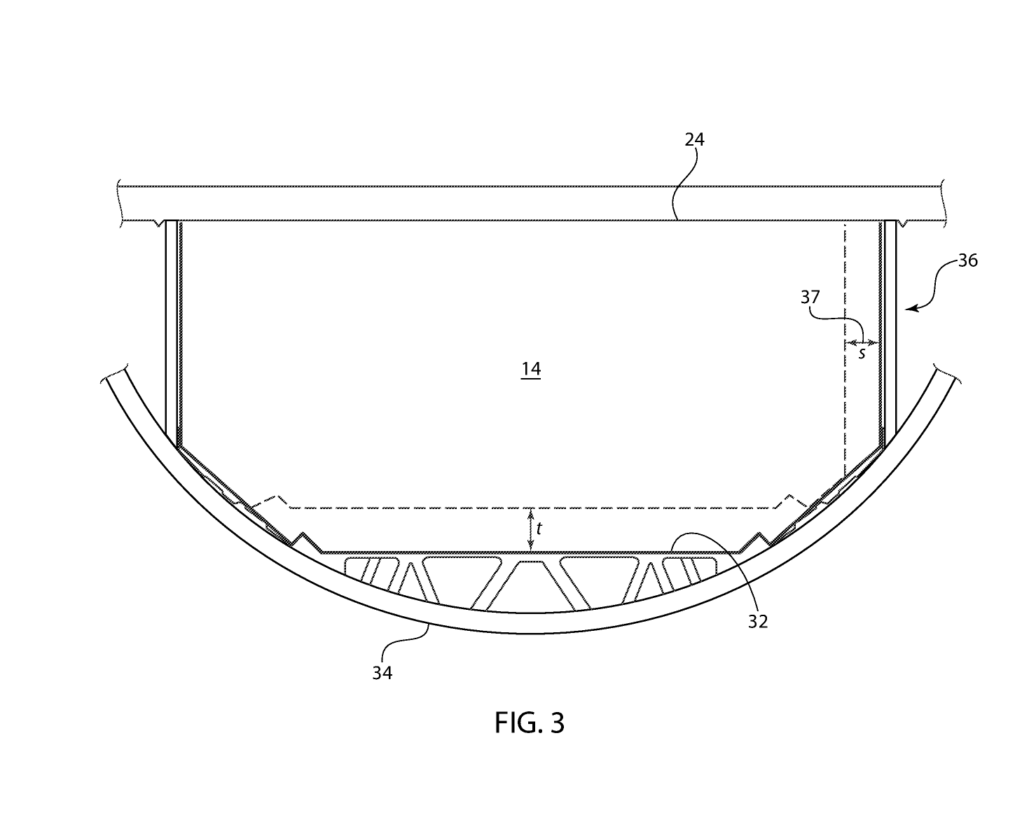

Lowered technical floor. The lower deck cabin 14 may also be provided with a lower deck cabin floor 32 (or deck passenger floor 32). The lower deck cabin floor 32 is a technical floor, i.e., a floor on which the passengers stand. In order to provide enhanced room for passengers and crew in the lower deck cabin, the cargo area technical floor, which functions as the lower deck cabin floor 32 on which passengers stand, may be lowered, as shown in FIG. 3. This lowering of the lower deck cabin floor 32 allows the cabin arrangement of the lower deck cabin 14 to host most passenger heights. This can provide an acceptable height of the partition structure 24 of the lower deck cabin 14 so that passengers do not feel cramped. It also helps enable crew to provide in-flight services in a comfortable way, such as catering, duty-free shopping, and so forth.

In a specific example, the distance between the lower deck cabin floor 32 of the lower deck cabin 14 and the partition floor/ceiling 24 of the lower deck cabin 14, actually formed by a technical floor of the main deck cabin 12, may be about 78 inches. The distance between the lower deck cabin floor 32 and a fuselage internal curved surface 34 (the actual internal curved surface 34 of the aircraft fuselage 10, often referred to as the “fuselage belly 34”) may be any appropriate dimension that can allow the desired cabin space in the lower deck cabin.

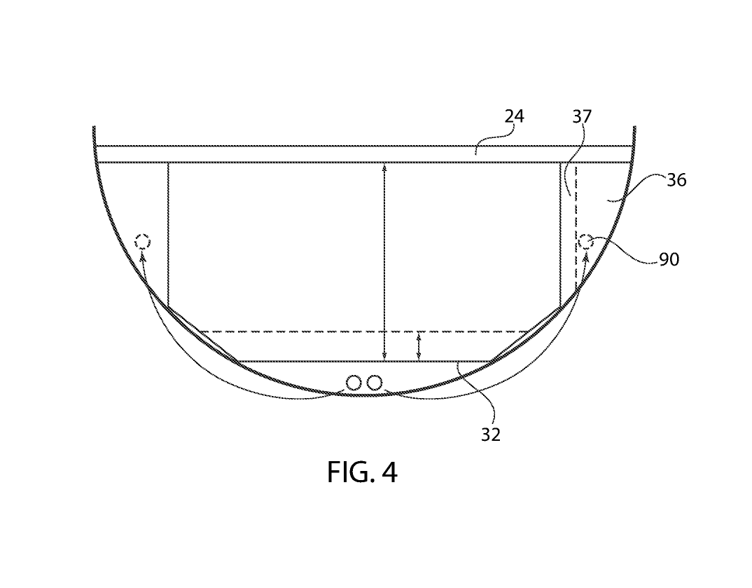

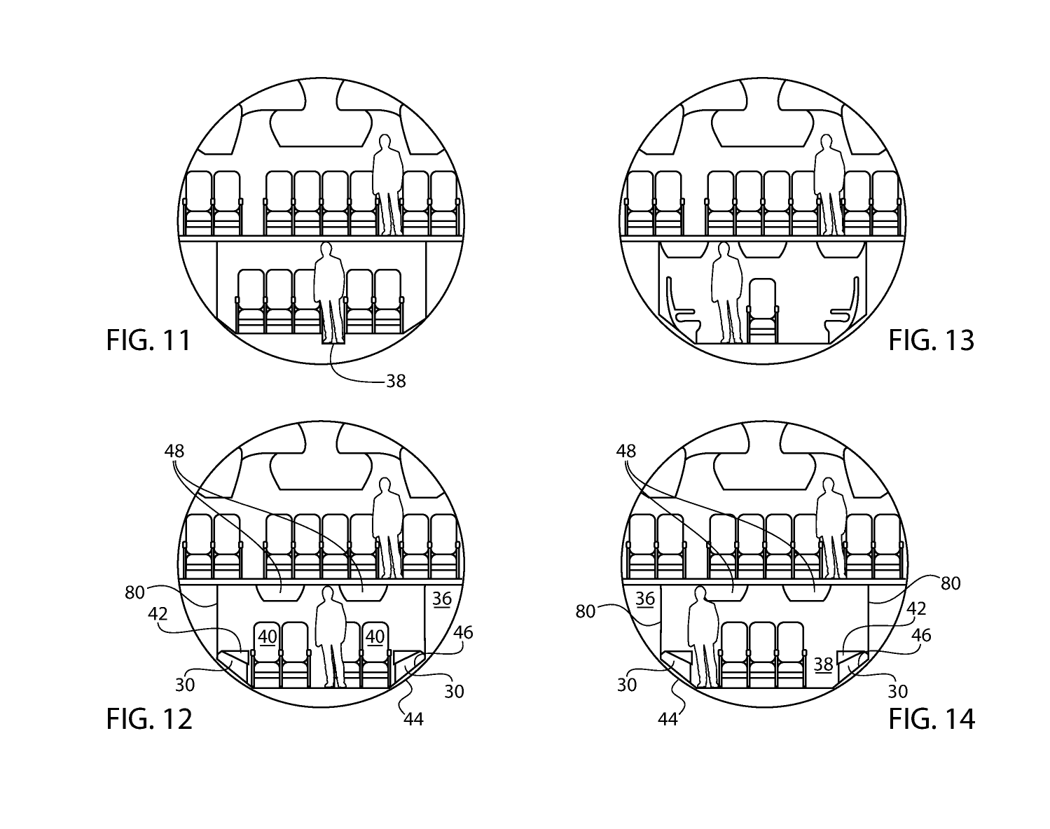

At least a portion of the lower cabin deck floor 32 of the lower deck cabin 14, along with corresponding girders, struts, or other support structures, may be depressed or lowered a distance “t,” as is shown in FIG. 3. Lowering the entire existing lower deck cabin floor 32 of the lower deck cabin 14 provides a desirable lower deck cabin ceiling height. In one example, lowering the entire existing floor the distance “t” provides a full flat floor which can be used for various passenger seating configurations. In another example, the cabin floor 32 may only be lowered along an aisle section 38. This example is illustrated by FIGS. 2 and 11. With this lowering of the lower deck cabin floor 32, whether it be a full floor or an aisle section only, it may be necessary to re-locate one or more pipes 90 or other structures, as illustrated by FIG. 4. The re-location is optional only. If required based on the particular design to be implemented, FIG. 4 shows re-locating pipes 90 into sidewall spaces 36 of the lower deck cabin 14.

In a specific embodiment, the entire lower deck cabin floor 32 may be lowered to be closer to the fuselage internal curved surface 34. This may be done using support elements and/or alternatively shaped girders and struts. Various embodiments for lowering of the floor are described at least by U.S. Pat. No. 5,752,673.

It may also be possible to provide the lower deck cabin 14 with an additional wall thickness 37. One example is shown by FIGS. 3 and 4. This additional wall thickness 37 may be provided in order to prevent passengers from coming into contact with non-authorized, corrosive, and/or dangerous liquids that may be transported along the lower deck cabin walls, into the sidewall spaces 36 of the lower deck cabin 14 or along the lower portion of the aircraft. This can help establish a required level of safety by providing a seal between the skin of the aircraft and the lower deck cabin 14. The space of wall thickness 37 may range from about 0.1 to about 10 inches in one example. In other examples, wall thickness 37 may be between about 0.4 to about 5 inches. In an even more particular example, it may range from about 0.5 to about 2 inches, and in a specific example, wall thickness 37 may be about one inch.

Providing the additional wall thickness 37 may help to provide a sealed cabin, which can also assist with noise reduction. It is possible to add an additional material that helps absorb noise, such as an insulation type material. It is also possible to provide a system that provides active noise reduction, such as an electronic system with input/output that can produce an opposite phase on the noise. For example, there may be microphone input that receives noise and an output speaker that converts the noise to an opposite phase and projects the noise back into the cabin.

Passage from the upper deck cabin to the lower cabin deck. Additionally, the present disclosure may provide a staircase at both ends of the lower deck cabin 14. This allows for ease of boarding, de-boarding, and enhanced flow in the event of an unplanned evacuation. As shown in FIG. 1, there may be provided with at least one separate forward portion 18 and aft portion 20 of lower deck cabin 14. Separate forward portion 18 and aft portion 20 may need to be provided in order to accommodate for the central portion 100, which may house a central wing fuselage and one or more compartments that may house air-conditioning units and other aircraft operation technology. Separate forward portion 18 and aft portion 20 may also be provided in order to allow for cargo storage in other lower areas of the fuselage as well.

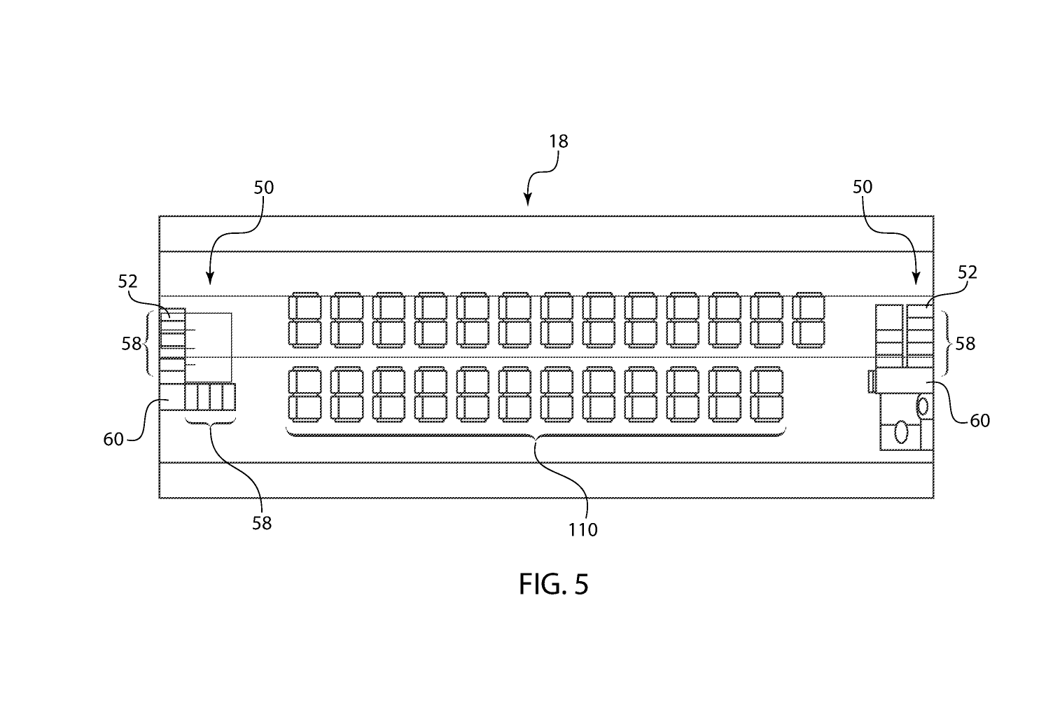

In one example, there may be provided only a forward portion 18. In another example, there may be provided only an aft portion 20. In a further example, there may be provided both a forward portion 18 and an aft portion 20. In a further alternative example, there may be several forward portions 18 and/or several aft portions 20. Each of the forward portion 18 and of the aft portion 20 may be considered a separate lower deck cabin 14, having the features described herein. FIG. 5 illustrates one example of a forward portion 18, but it should be understood that a similar configuration may be provided for the aft portion 20.

Some of the earlier attempts at providing lower deck cabins have provided a central staircase. However, the present inventors have found that this configuration is not optimal for space or safety. Accordingly, embodiments described herein provide each lower deck cabin 14 with two passageways 50 between the main deck cabin 12 and the lower deck cabin 14. The two passageways may be positioned at opposite ends of a passenger seating area 110.

As shown in FIG. 5, it is possible for these passageways 50 to be stairways 52. According to most federal regulations, the stairways 52 may either include a completely straight route segment 58 or one or more straight route segments 58 divided by landing 60 at each change in segment direction. Due to space considerations, is expected that one or more straight route segments 58 divided by one or more landings 60 may allow a better use of space, and require fewer loss of passenger seats in the architecture. However, it should be understood that straight route segments 58 alone may also be used and are considered within the scope of this disclosure. Additionally, it should be understood that although described and shown as stairways 52, it is possible for passageways 50 to be provided as hatches with drop down ladders, or any other method that allows movement between the main deck cabin 12 and the lower deck cabin 14.

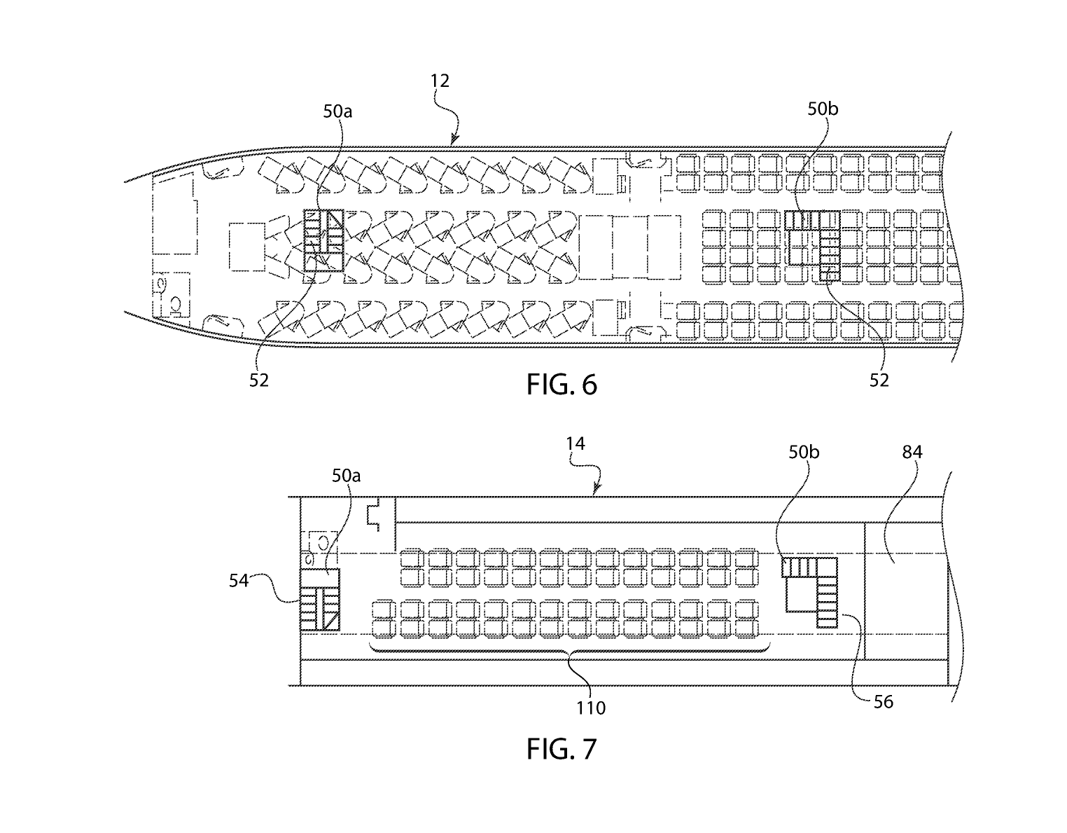

FIG. 6 illustrates one potential layout of the main deck cabin 12, showing where loss of passenger seats may occur in order to provide passageways 50. In this example, the passageways 50 are provided as stairways 52. As a particular example, one of which may be located in business class and one of which may be located in economy class, both of which serve the forward portion 18. FIG. 7 illustrates one potential layout of the corresponding lower deck cabin 14, showing where passageways 50 may be located.

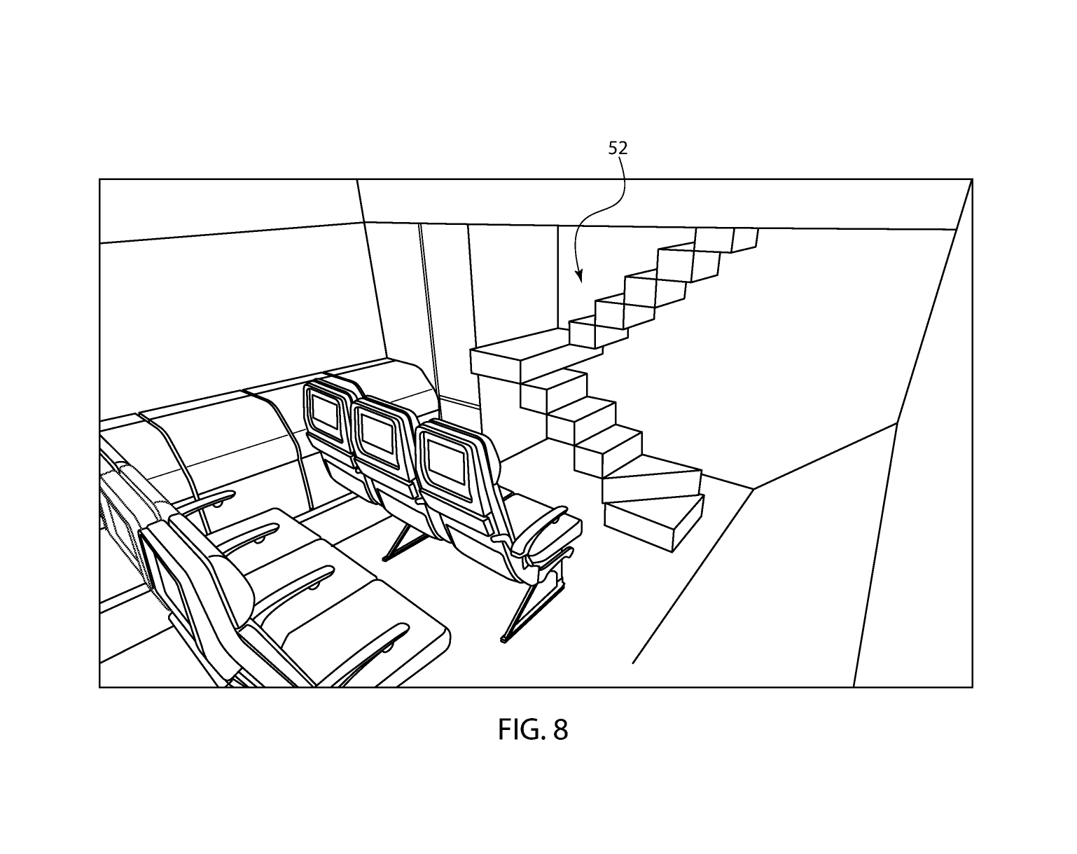

The presence of one or more stairways 52 requires a loss in passenger seats or other features on the main deck cabin 12, in order to provide the passageway 50. By providing a first passageway 50a near a front end 54 of the lower deck cabin 14, illustrated as a stairway 52 in FIG. 8, and a second passageway 50b near a rear/aft end 56 of the lower deck cabin 14, illustrated as a stairway 52 in FIG. 9, movement between the main deck cabin 12 and the lower deck cabin 14, in particular between the main deck cabin 12 and the forward portion 18 and/or the aft portion 20 of the lower deck cabin 14, can be streamlined. This can be particularly beneficial for boarding and de-boarding, and perhaps more importantly, in a water evacuation. As described below, in the event of a water evacuation, one or more of the exit doors of the lower deck cabin 14 may be below the waterline and unusable.

Exit doors and emergency evacuation. The number of passengers permitted in an aircraft is governed by the number, type, and location of installed emergency exits. Different door sizes can accommodate different numbers of passengers. For example, a Type A door can accommodate 110 passengers, a Type B door can accommodate 75 passengers, and a Type C door can accommodate 55 passengers.

If, for example, the lower deck cabin 14 were to be designed to hold 110 passengers, there would either need to be provided one Type A door or two Type C doors accessible for the passengers of the lower deck cabin 14, and so forth. In one example, the lower deck cabin 14 is provided with sufficient emergency exits that allow evacuation of the entire number of passengers that can be seated in the lower deck cabin 14 from the lower deck cabin 14 itself.

However, because the lower deck cabin 14 is potentially below the waterline 62 of the aircraft (which is shown in FIG. 1 at a generally similar level as the horizontal wing plane), a water landing/evacuation may dictate that the passengers of the lower deck cabin 14 to evacuate from emergency exits on the main deck cabin 12 instead of from the lower deck cabin 14. In this instance, the main deck cabin 12 may be provided with sufficient emergency exit doors 64 to accommodate all of the passengers on-board, including the number of passengers that can be accommodated in the lower deck cabin 14. As described above, the passageways 50 from the lower deck cabin 14 to the main deck cabin 12 may be sized and dimensioned to be sufficient to allow ingress and egress of passengers in an expedited manner.

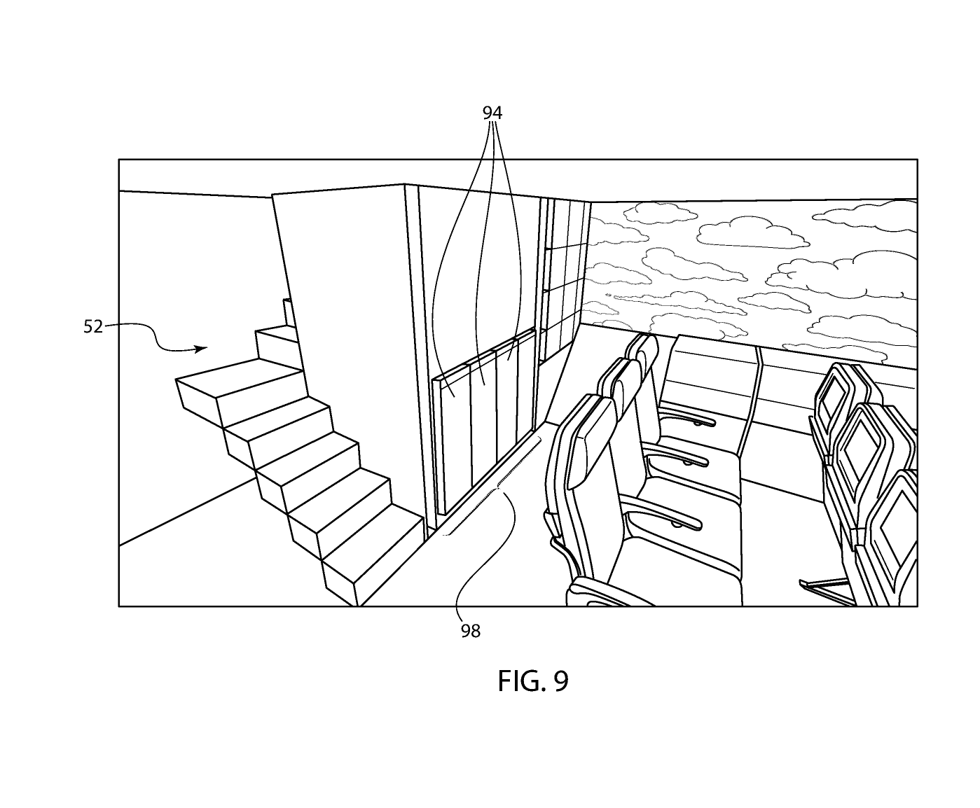

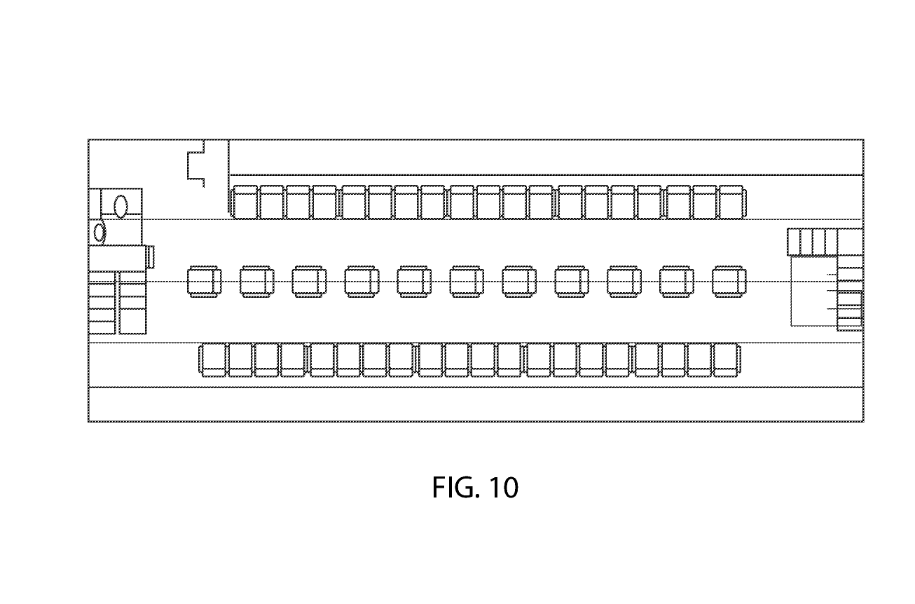

Seat layout. There may be provided a first-class section, a business class section, and/or economy class seat section provided. Any combinations of these options are possible. In addition, an alternative class can be offered since the lower deck cabin 14 can be designed as a stand-alone cabin. Different configurations may be set up, such as high comfort, high-density, or high flexibility. Within these configurations, different seats and different seating directions may be used. For example, seats may face forward as is shown in FIGS. 5-9, may face aft, or may face an interior portion of the aircraft as shown in FIG. 10. FIGS. 5-15 show optional seating designs.

For example, as shown in FIG. 11, the seat layout may include a five-abreast configuration in the lower deck cabin 14. There may be three seats on one side of an aisle of the lower deck cabin 14 and two seats on the other side. FIG. 12 illustrates a four-abreast configuration, with two seats on one side of the aisle of the lower deck cabin 14 and two seats on the other side. FIG. 13 illustrates an outboard configuration, with a central column of single seats and two side columns of seats that face inwardly. This is also illustrated by the schematic of FIG. 10. FIG. 14 illustrates a three-abreast configuration, with three adjacent seats. It should be understood that combinations of these configurations along with other configurations are possible and considered within the scope of this disclosure.

It may be possible to provide the lower deck cabin 14 with modularity, such that the seating capacity of the aircraft can be increased when required, as long as a corresponding reduction in the cargo area to be loaded is possible. It is possible for one or more seat tracks to be removable, such that the lower deck cabin 14 may be reconfigured as desired.

Crew rest area. As a particular embodiment, FIG. 7 illustrates that the lower deck cabin 14 may also be provided with an optional crew rest area 84. The crew rest area 84 may have at least one bunk and/or at least one seat. This crew rest area 84 may be provided with a hatch to the main deck cabin 12, which can provide a potential additional emergency exit from the lower deck cabin 14. In addition, the crew rest area 84 may also have a door to provide a direct access between the lower deck cabin 14 and the crew rest area 84. In the embodiment shown, the crew rest area 84 is generally located aft of the passenger seating portion 110 and aft of the passageway 50. It should be understood, however, that the crew rest area 84 may be located elsewhere.

Luggage storage. One of the space challenges associated with the lower deck cabin 14 relates to storage. Because of the desire to provide an appropriate cabin height and a feeling of spaciousness in the lower deck cabin 14, it may be desirable to provide additional storage options. These additional storage options may be in addition to or instead of overhead compartments 28 typical to those provided in the main deck cabin 12. Accordingly, various luggage storage options are disclosed.

In one example, it is possible to provide lower storage bins 30. Examples are shown by FIGS. 12 and 14. Lower storage bins 30 may be positioned adjacent to an outer seat 40 in a particular row, as shown by FIG. 12. Lower storage bins 30 may be positioned adjacent an aisle 38, as is shown in FIG. 14. Lower storage bins 30 may be provided as fixed lower storage bins 30 that have an openable lid 42. The lower storage bins 30 may be fixed to a fuselage in order to provide structural support. For example, there may be one or more brackets provided that link the storage bin 30 to a portion of the fuselage 10. In other embodiments, there may be provided one or more seat tracks that can be configured to secure one or more lower storage bins 30. In other embodiments, the lower storage bins 30 may be secured via one or more hard points between the ceiling (partition floor 24) and the fuselage 10. It is generally beneficial to provide portions on the floor that can support and reinforce the load to be contained in the lower storage bins 30. The lower storage bins 30 may have a structure that allows them to withstand crash loads.

In one example, the lower storage bins 30 may additionally be fixed to the sidewall 80. This sidewall 80 may be provided to help with adding the additional wall thickness 37 that may be desired in many instances. The lower storage bins 30 and the sidewall 80 may be secured to one another and provide an additional cabin sealing function.

The lower storage bins 30 may be useful to take advantage of a curved side 44 of the aircraft fuselage 10. As shown, the lower storage bins 30 may have an angled rear 46, which can allow the lower storage bins 30 to take advantage of the curved side 44. Lower storage bins 30 may be used in addition to or as a replacement to traditional overhead compartments. There may be provided a span of lower storage bins 30, such that an elongated bin base having multiple dividers and multiple lids can serve multiple seats. Alternatively, there may be provided a plurality of individual lower storage bins 30, with a single bin serving a single row.

As shown in FIGS. 12-14, it is possible to provide the overhead element 48 that displays seatbelt signs and that holds oxygen masks. These overhead elements 48 encroach less on passenger space than traditional overhead baggage compartments, and are also required for safety purposes.

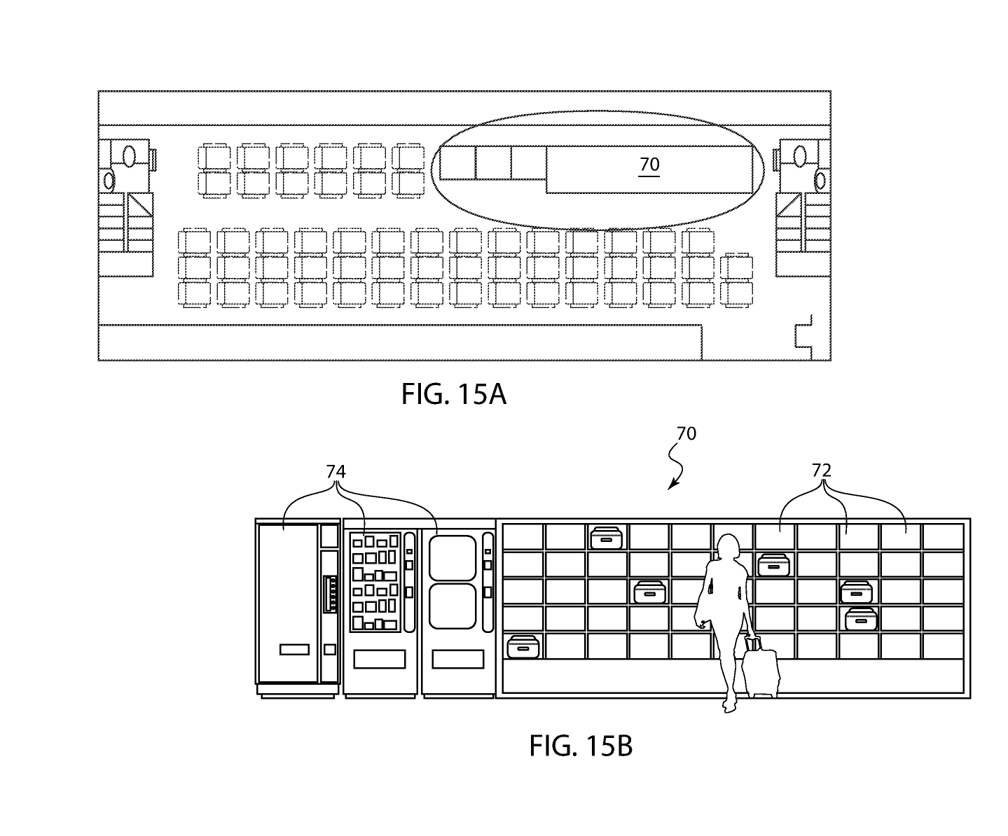

An additional or alternate solution for passenger luggage is to provide a cabin luggage storage area 70, preferably a separate cabin luggage storage area 70. As shown in FIGS. 15A and 15B, this cabin luggage storage area 70 may be positioned along one wall and may be provided with a plurality of cubbies 72. Each of the cubbies 72 may be sized and dimensioned for holding a passenger carry-on item. Although shown as generally having similar dimensions, it is also possible to provide larger and smaller cubbies 72, in combination. The cubbies 72 may be open-faced, but it is generally expected that each cubby and/or each row of cubbies would be provided with a closure door (not shown for ease of viewing). FIG. 15b also shows optional vending machines 74, which may help provide enhanced comfort and enjoyment for passengers.

Passenger comforts. The lower deck cabin 14 may be provided with a dedicated lower deck galley 92. In other embodiments, trolleys 94 for catering services may be provided to the lower deck galley 92 via a trolley lift, which can connect the main deck cabin 12 with the lower deck cabin 14. For example, trolleys 94 may be raised and lowered between the main deck cabin 12 and the lower deck cabin 14, such that beverage and meal service may be provided to the lower deck cabin 14.

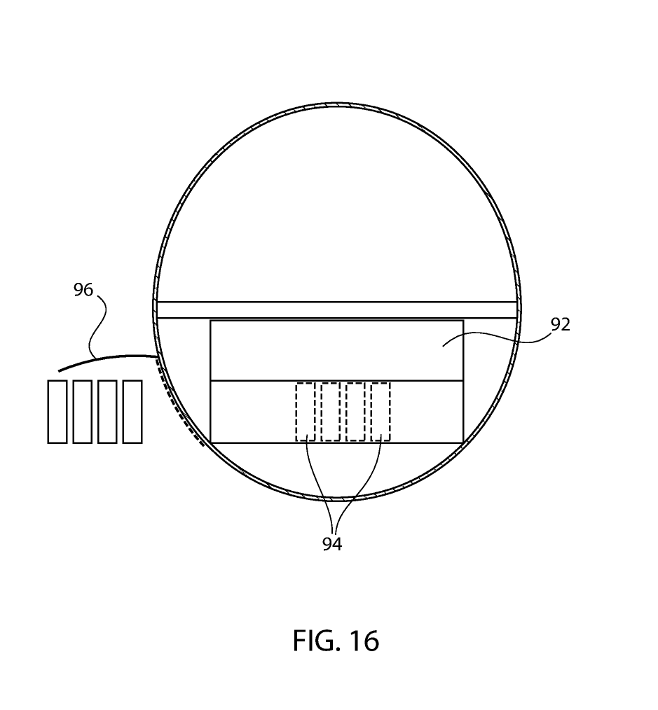

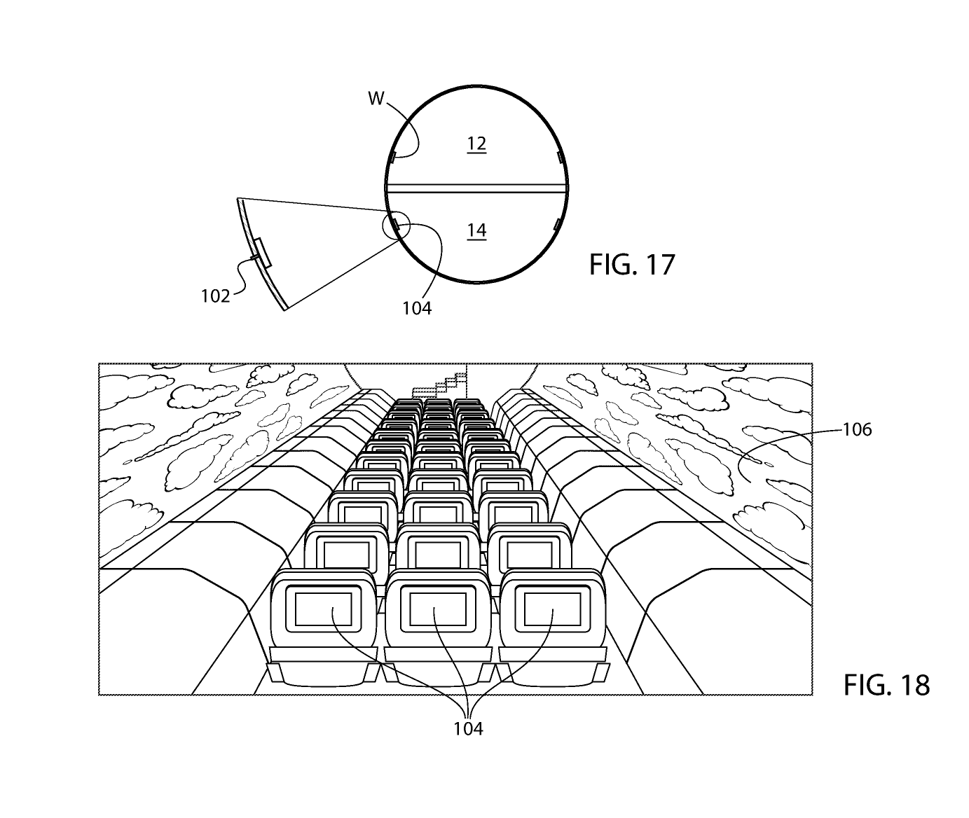

One example is shown in FIG. 9, where the trolleys 94 are shown in a trolley storage area 98. These trolleys 94 may either be raised and lowered up to the main deck cabin 12, or they may be positioned in a lower deck galley 92. For instance, it is possible to provide trolleys 94 that are dedicated to the lower deck cabin 14. These trolleys 94 may or may not be associated with a dedicated lower deck galley 92. As shown in FIG. 16, these trolleys 94 may be loaded via an existing cargo door 96, or a door within the existing cargo door 96.

Additionally or alternatively, it is possible to provide one or more vending machines 74 to provide catering functions in the lower deck cabin 14. Passengers may be able to select various beverages and/or snack or meal items for consumption in the lower deck cabin 14, without having to travel to the main deck cabin 12.

Window replacement. Additionally, in the lower deck cabin 14, there is an absence of physical windows with the direct view to the exterior of the aircraft. In order to accommodate for this, it is possible to provide one or more screens configured to display images from outside the aircraft. This may be done for passenger comfort and entertainment, as well as to help prevent airsickness, help reset passenger circadian rhythms, and to provide information about the aircraft's current location.

The screens may provide a live view from the outside world during the passenger journey. The provided live view suggests motion in line with the movement of the aircraft itself. It may be desirable for the provided live view to correspond to the viewing direction of the passenger. For example, if the live view is provided on a sidewall, then images from that side of the aircraft may be provided. For example, if the live view is provided on a front wall, images from the front of the aircraft may be provided, and so forth.

In one example, there may be provided one or more cameras 102 that project a digital window onto a screen 104. The screen 104 may be provided along the aircraft wall at a location where a window “W” would otherwise be located on the main deck cabin 12. This may provide a “window” feel, with an image that represents the exterior of the aircraft. There may even be provided a shade that can allow passengers to have the window display accessible, or that will allow the shade to be drawn down.

And another example, as shown in FIG. 18, the screen 104 may be provided in a location where an in-flight entertainment (IFE) unit would be provided. For example, a passenger may be able to select from options including watching a movie, listen to music, viewing flight information, or having a digital window project onto the forward screen.

In another example, an interior wall 106 of the aircraft may be an elongated screen that allows the entire outside view to be displayed thereon. One example is shown by FIGS. 9 and 18. In these figures, the live view is provided by projecting the view on the interior wall 106 of the aircraft fuselage 10. It is also possible to use the walls, floor, and or ceiling of the lower deck cabin 14 to provide a desired live view.

In another example, non-integrated devices, such as passenger smart phones, tablets, laptops and/or wearable devices may be used to project the desired live view. For example, it may be possible for users to download an application onto their device that will allow the live view to be streamed to the device.

In one example, the images may be captured by and projected from one or more cameras 102 positioned external to the aircraft. Existing and/or newly installed cameras may be used to capture the live view. Newly installed cameras may be installed in a way that causes the least drag during the flight. For example, a camera system may be provided that is flush with the aircraft skin. In another example, the images may be provided by one or more cameras provided along one or more locations on the aircraft skin, or extending through the aircraft skin, such that images collected may be displayed on one or more screens in the lower deck cabin 14. In a specific example, a fiber optic camera may be used. Technologies such as LED, AMOLED, OLED, smart textiles, and/or any other technologies that can provide the live view image within a lower deck cabin 14 are considered within the scope of this disclosure.

It is possible to allow the window replacement system to be autonomous, such that it uses an independent power from the aircraft.

Safety. In one example, the lower deck cabin 14 may be provided with its own portable oxygen bottles, fire extinguishers, first aid kits, and other safety items required by the Federal Aviation Administration (FAA) or other regulatory body.

Because there are typically no windows within the lower deck cabin 14, emergency lighting may be provided by an autonomous and independent power system.

The installation of one or more passenger emergency exit doors within the existing cargo door 96 may provide an additional level of safety to passengers.

The installation of one or more overhead hatches can also provide an additional exit routes.

In order to allow use of the lower deck cabin 14 for passenger seating, particularly during taxi, takeoff, and landing (TTL), the aircraft may be provided with one or more energy absorbing structures. Such energy absorbing structures provide energy absorption upon the event of a crash or emergency landing in order to protect passengers in the lower deck cabin 14. The energy absorbing structures may be realized in a number of different ways. For example, there may be energy absorbing seats provided. The seats may be designed to have one or more shock absorbing features. In another example, energy absorbing structures may be provided as an external structure that is attached to the aircraft fuselage 10. They may be provided as a framework of collapsing struts. They may be provided as an energy absorbing foam core. They may be provided as energy absorbing structure that is positioned within the skin of the aircraft. Various deformation structures are available that act as a crumple zones, which may be arranged on the fuselage shell, underneath the lower deck cabin for safety measures. It is also possible to incorporate one or more energy absorbing structures into the passageway/stairways provided. It is also possible to incorporate one or more energy absorbing structures into the monuments of the lower deck cabin, such as lavatories and galleys, or other monuments. It is also possible for the one or more monuments to help reinforce the lower deck structure.

It is also possible to provide reinforcements on the passageways/stairways that function to ensure that the stairway(s) and/or monuments remain functional in the event of a crash in order to allow for evacuation. For example, the stairways and/or monuments may be formed integrally with the fuselage or otherwise as a structural part of the aircraft. The general goal is to ensure that passenger evacuation remains possible.

Changes and modifications, additions and deletions, combinations of different embodiments here above described may be made to the structures and methods recited above and shown in the drawings without departing from the scope or spirit of the disclosure or the following claims.

1. An aircraft fuselage defining an internal space and having a horizontal wing plane, comprising:
a partition floor dividing the internal space into a main deck cabin located generally above the wing plane and a lower deck cabin located generally below the wing plane, wherein each of the main deck cabin and at least a portion of the lower deck cabin are configured for passenger transport and have one or more seating areas;
the lower deck cabin comprising a first and second passageways between the upper main deck cabin and the lower deck cabin, the first passageway positioned at one end of the lower deck cabin seating area and the second passageway positioned at an opposite end of the lower deck cabin seating area.

2. The aircraft fuselage according to claim 1, wherein the first and second passageways comprise stairways.

3. The aircraft fuselage according to claim 2, wherein the stairways comprise one or more straight route segments with a landing at each change in segment direction.

4. The aircraft fuselage according to claim 1,
wherein the lower deck cabin comprises a lowered technical floor.

5. The aircraft fuselage according to claim 1,
wherein the lower deck cabin comprises a sidewall having an increased thickness.

6. An aircraft fuselage defining an inner space and having a horizontal wing plane, comprising:
a main deck cabin and a lower deck cabin, wherein the lower deck cabin is located below the horizontal wing plane, wherein at least a portion of the lower deck cabin is configured for passenger transport and comprises one or more display screens for displaying images retrieved from one or more cameras external to the aircraft in order to accommodate for a lack of windows in the lower deck cabin.

7. The aircraft fuselage according to claim 6, wherein the one or more display screens comprise in-flight entertainment units.

8. The aircraft fuselage according to claim 6, wherein the one or more display screens comprise screens positioned where windows would otherwise be located.

9. The aircraft fuselage according to claim 6, wherein the one or more display screens comprise elongated side walls of the lower deck cabin.

10. The aircraft fuselage according to claim 6, wherein the one or more cameras comprise fiber optic cameras.

11. An aircraft fuselage defining an inner space, comprising:
a main deck cabin and a lower deck cabin,
a partition floor generally positioned at wing level that divides the main deck cabin from the lower deck cabin,
wherein at least a portion of the lower deck cabin is configured for passenger transport and comprises one or more side bins positioned along a lower deck cabin sidewall.

12. The aircraft fuselage of claim 11, wherein the one of more side bins are secured via a bracket between the fuselage and the side bin.

13. The aircraft fuselage of claim 11, wherein the one of more side bins are secured via one or more seat tracks to a floor of the fuselage.

14. An aircraft fuselage defining an inner space, comprising:
a main deck cabin and a lower deck cabin,
a partition floor generally positioned at wing level that divides the main deck cabin from the lower deck cabin,
wherein at least a portion of the lower deck cabin is configured for passenger transport and comprises a luggage storage area rather than or in addition to overhead storage compartments.

15. The aircraft fuselage of claim 14, wherein the luggage storage area comprises a plurality of cubbies.

16. The aircraft fuselage according to claim 14,
wherein the lower deck cabin is provided with a crew rest area having at least one bunk or at least one seat or both.
